(19) United States
(12) Patent Application Publication
(10) Pub. No.: US 2012/0175052 A1
(43) Pub. Date: Jul. 12, 2012

(54) Combination buckram applicator, pleat and hem marker and cutter for drapery material

(76) Inventor: Ronald Wade Morgan, Louisville, KY (US)

(21) Appl. No.: 13/068,365

(22) Filed: May 9, 2011

Related U.S. Application Data
(60) Provisional application No. 61/395,140, filed on May 8, 2010.

(51) Int. Cl. B32B 38/04

(52) U.S. Cl. 156/251; 156/354

(57) ABSTRACT

An apparatus for preparing a cut length of cloth for sewing a drapery panel which feeds out a selected amount of cloth, provides alignment guides to fit a length of buckram into the proper location for attachment to the piece of cloth, aligns a cutter to the proper position to cut the proper length of cloth, sprays an ultra violet line to mark the edge of the hem as the cloth is cut and includes a marking gauge for hand or automatic marking the proper position for the pleats. The resulting piece of cloth is ready to be sewn singly or with other pieces into a drapery panel and to have the pleats or rod pockets sown.

### CROSS REFERENCE TO RELATED APPLICATIONS

This application also claims priority from Provisional Application Ser. No. 61/395,140 filed on May 8, 2010 which is incorporated by reference in its entirety herein.

### TECHNICAL FIELD

The present invention relates to the field of equipment used to make drapes and more particularly equipment which enables cutting to length and preparation of cloth for sewing drapery panels and sewing in the pleats.

### DESCRIPTION OF THE RELATED ART

The applicant is unaware of another apparatus in the art which contains the same elements and performs the same functions as the invention described herein.

### BACKGROUND OF THE INVENTION

Applicant's U.S. Pat. No. 3,996,083 for PROCESS FOR MAKING DRAPERIES issued on Dec. 7, 1976 teaches and apparatus for facilitating the proper alignment and application of buckram to a cut piece of cloth. The apparatus described in U.S. Pat. No. 3,996,083 is not capable of holding a bolt of cloth and feeding out a selected length, does not provide a cloth cutting member which is configured to facilitate required straight and properly positioned cut, and does not facilitate the marking of a bottom hem position or the proper position for required pleats.

The present invention provides an apparatus which holds a bolt of cloth so that cloth can be fed from the bolt, feeds a selected amount of cloth from the bolt, holds the cloth in proper alignment for buckram application and cutting, provides alignment elements for the proper placement and application of buckram which is provided with adhesive,
provides a cloth cutting device which is capable of cutting the cloth to the proper length accurately and straight,
provides an alignment gauge for marking the proper position for pleats,
provides an ultraviolet marker which marks the proper bottom hem position while the cutting device performs the cut, and
removes and stacks the cut portions of cloth for removal by a user.

### SUMMARY OF THE INVENTION

The steps for fabricating a drapery without the use of the present invention are as follows:
1. Fabric is measured and may be inspected.
2. Fabric is cut to length and this piece of fabric is commonly called a ‘width’.
3. A selected number of widths are sewn together to form a ‘panel’
4. The side hem is sewn along the sides.
5. Then the bottom hem and/or heading, near top of the panel, is installed as follows. If the bottom hem is sewn first, the panel is then measured to length and the heading (a stiff material such a buckram) is attached near the top edge of the panel for pleated drapes. On the other hand, if the heading is installed first, then the finished length is measured and the bottom hem is sewn or glued. Where pleats are not needed, rod pockets or tabs may be sewn in near the top of the panel.
6. The drapery can now have the pleats, rod pockets or tabs sewn.
7. The drapery can now be folded and bagged for delivery.

The present invention eliminates the steps of measuring for length, hem or pleats and facilitates the cutting of the ‘width’ and the installation of the buckram and marking of pleats and automatically marks the hem position as the ‘width’ is being cut. A ‘width’ is a piece of drapery material which has been cut to length, has buckram installed if required, and is ready to be sewn into a drapery panel.

The steps for fabricating a drapery using the present invention are as follows:
1. Fabric bolt is placed and threaded on the machine.
2. Finished length is programmed into the machine.
3. The fabric advances over the platform on the machine and stops so the buckram can be attached and the heading is marked either for pleats, rod pockets, etc.
4. Then the fabric advances into position where the ‘width’ is cut to length just past the buckram which was just installed for the next ‘width’ . Simultaneously, an ultraviolet mark is sprayed onto the ‘width’ marking the proper position for the bottom hem.
5. The machine then automatically removes and stacks the cut ‘width’.
6. One or more widths can now be sown together, hemmed and pleated.

The present invention does away with the need to measure the length to cut the material, to measure or mark hems or pleats since they are already marked, or to measure and install the buckram by hand.

Presented herein is a combination buckram applicator, pleat and hem marker and cutter for drapery material comprising, consisting of, or essentially consisting of a frame comprising and open box like structure wherein longitudinal members form each edge of the open box structure, the frame including a work table affixed to a front side of the frame, the work table including a planar surface with buckram alignment guides, a buckram bracket configured to rotatably hold a coil of buckram to be applied to drapery material, the table also including an adjustable pleat marking alignment gauge, a front drapery material clamp fixed at a front edge of the work table, and a bolt holding cradle containing rollers which is configured to either allow a bolt of drapery material to be freely spun or the rollers may be motor driven to provide drapery material tension control if desired. The frame also includes a pair of motor driven continuous loops of chain connected by two pairs of drapery material carrier rollers, a drapery ‘width’ receiver frame which is configured to be raised to a drapery ‘width’ receiving position and lowered to a drapery ‘width’ removal position, a rear drapery material clamp and shelf, the shelf being located behind a rear edge of the work table with the pair of chains moving upward vertically through a gap between the shelf and the work table, the pair chains further traversing upward to a top portion of the frame, back to a rear edge of the frame and then returning downward to a location under the shelf and the rear clamp. Power shears are slidably mounted on a drapery cutting guide with a limit switch at both ends of travel on the cutting guide, the shears have an ultraviolet hem marking sprayer. One of the limit switches senses that a cut has been performed and thus causes the controller to open the rear clamp and to drive the chain drive motor to carry a newly cut ‘width’ away from the power shears. The other of the pair of switches senses that the power shears have been return to a power shear hold position thus causing the controller to close the rear clamp onto the newly cut free end of the drapery material. There are pneumatic solenoids for controlling the ultraviolet sprayer and pneumatic cylinders for the front and rear material clamps. There is also an operator panel including operational switches and a programmable controller for controlling the chain drive motor, the cradle roller motor, and the solenoids. The programmable controller receives inputs from operator switches, limit switches and a drapery material length monitoring device. The programmable controller is programmed to receive a selected cut length value and capable of controlling the clamps and the chain drive motor to deliver drapery material at a selected position to apply buckram and to deliver the drapery material at the selected cut length whereupon a user can cut the selected length of material.

It is an object of this invention to provide an apparatus which holds a bolt of cloth so that cloth can be fed from a bolt or roll.

It is another object of this invention to provide an apparatus which feeds a selected amount of cloth for cut length from the bolt.

It is another object of this invention to provide an apparatus which holds the cloth and buckram in proper alignment for application and cutting.

It is an object of this invention to provide an apparatus which provides alignment elements for the proper placement and application of buckram.

It is another object of this invention to provide an apparatus which provides a cloth cutting device which makes and easy task of cutting the cloth to the proper length squarely and accurately.

It is another object of this invention to provide an apparatus which provides an alignment gauge for marking the proper position for pleats.

It is another object of this invention to provide an apparatus which provides an ultraviolet marker which marks the proper bottom hem position while the cutting device performs the cut.

It is another object of this invention to provide an apparatus which removes and stacks a plurality of cut portions of cloth for removal by a user.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a perspective view of the drapery cutting apparatus from an upper left viewpoint.

FIG. 2 is a left side view of the drapery cutting apparatus.

FIG. 3 is a front view of the cutting device and the ultraviolet marking device.

FIG. 4 is a left view of the exact stop device.

FIG. 5 is a left view of the work table.

FIG. 6 is a right perspective view of the drapery cutting apparatus.

FIG. 7 is a left perspective view of motor 19.

FIG. 8 is a front view of the operator control panel

### DESCRIPTION OF THE PREFERRED EMBODIMENTS

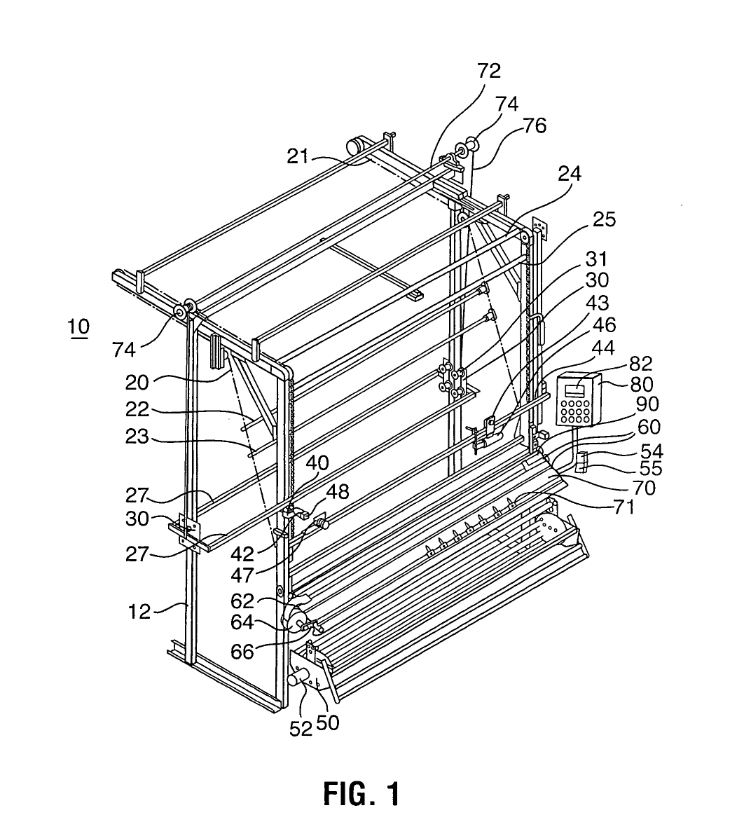

In accordance with the present invention, there is provided an apparatus for measuring a length of drapery material, applying buckram, marking for bottom hem and pleats, rod pockets or tabs, and cutting drapery material to length. Shown in FIG. 1, the drapery cutting apparatus 10 comprises a frame 12 comprising an open box like structure wherein longitudinal members form the edges of said box like structure, a work table 70, a bolt holding cradle 50, drive chains 20 and 21, carrier roller pairs 22/23 and 24/25, a drapery ‘width’ receiver frame 27 and an operator panel 80.

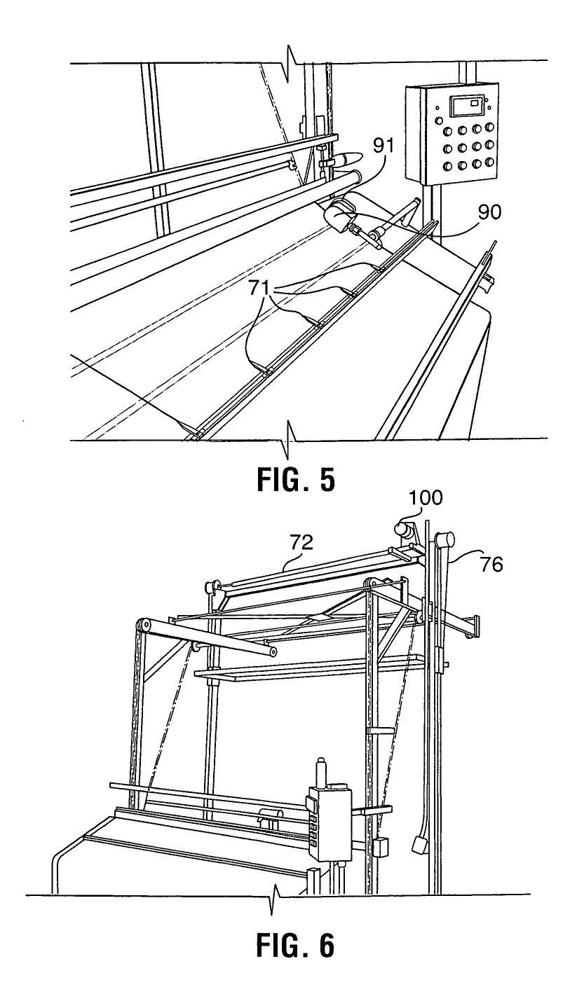

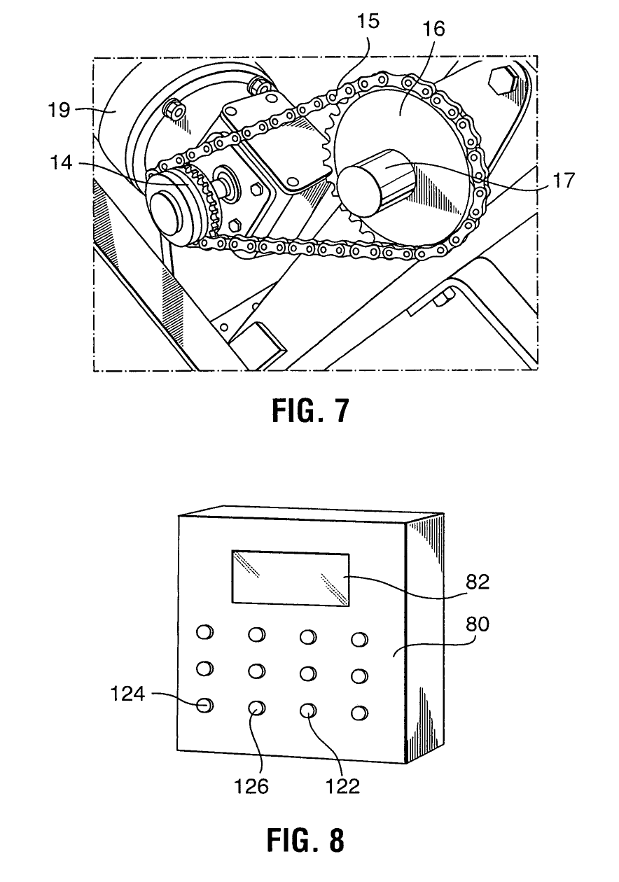

The chain pair 20/21 are driven by motor 19 which is controlled by a programmable controller 82. Controller 82 also controls solenoid valves 54 and 55 which operate pneumatic cylinders which open and close pneumatic clamps 94 and 95. Controller 82 is programmed with a selected length to which the drapery material shall be cut. When a user presses a particular switch on operator panel 80, controller 82 starts motor 19. Drapery length measuring device 90 gives controller 82 a signal as to the amount of material being pulled by means of a roller 91 which is caused to turn by the cloth passing underneath as shown in FIG. 5. When controller 82 senses that the proper amount of cloth has been dispensed, the controller stops motor19. Exact stop device 41, shown in FIG. 6, comprises a pneumatic cylinder 42 with a stop pawl 40 which is forced into a link of chain 20 as a positive stop measure. Stop pawl 40 is thrust into chain 20 by pneumatic cylinder 42 controlled by solenoid 48 which is energized by controller 82 at the same time motor 19 is stopped, to ensure that chain 20 is stopped immediately and the proper length of material will have been fed. Because inertia would tend to keep motor 19 turning for a short time, an overrun clutch 14 is included on the drive shaft of motor 19 to allow exact stop device 41 to stop chain 20 while inertia causes overrun clutch 14 to slip for a short time.

Chain pair 20/21 carries carrier roller pairs 22/23 and 24/25 in a cyclical path upward past the work table 70 to the top of frame 12, back toward the rear of the machine and back down below the work table 70 and then upward through the space between shelf 97 and work table 70.

It is understood that at the beginning of a cycle, a free end 114 of material 110 is held by rear clamp 95. A piece of buckram has already been adhered to the material 110 a few inches below free end 114. Front clamp 95 is released and raised above table 70 and drapery material 110 by pneumatic cylinders 96 on each end of front clamp 94. At this point in the cycle, the user is ready to advance material 110 to the position for applying the next piece of buckram as determined by counter 90.

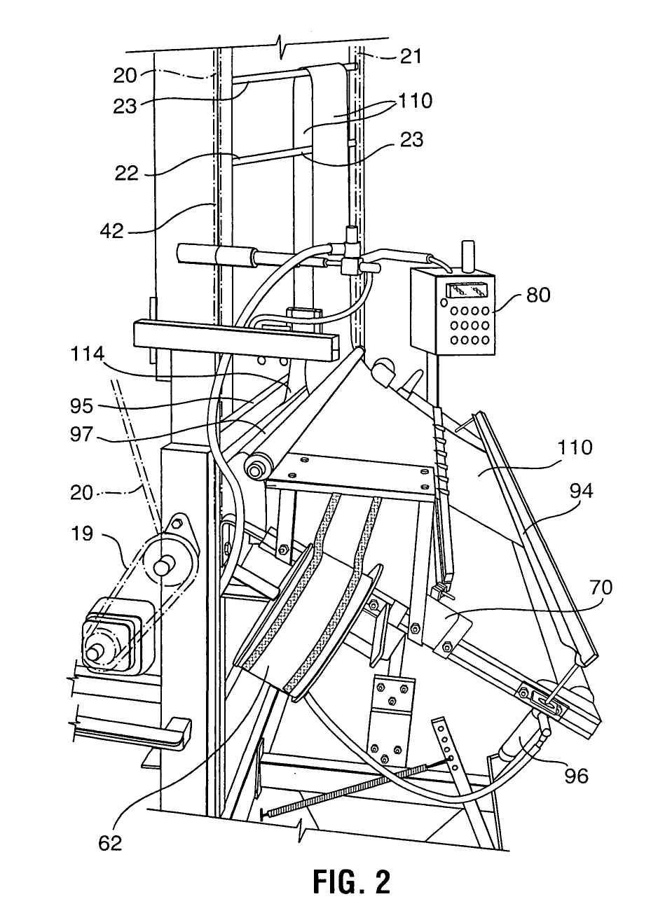

At the beginning of the cycle, the length of cut is programmed into the controller 82. The operator switches selector switch 126 to the “cut length” position and pushes the “cut length” button 122 which causes controller 82 to start motor 19. Chains 20 and 21 carry carrier roller 23 upwards between table 70 and shelf 97. Because rear clamp 95, as shown in FIG. 2, holds the free end 114 of material 110 tight against shelf 97, as carrier roller 23 moves upward, material 110 will be pulled upward by roller 23. Because controller 82 has been programmed to feed a selected length of material, motor 19 will stop and exact stop pawl 40 will be thrust into chain 20 automatically at a first position where the user will manually feed a length of buckram 62 from a coil 64 rotatably mounted on a bracket 66 through table guides 60. The buckram is provided with adhesive and can be cut and pressed by hand onto the under side of material 110. After the buckram is installed, the user uses adjustable pleat gauges 71 to align a handheld ultraviolet marker and make pleat marks on material 110. These marks will be used later when the pleats are made on another machine.

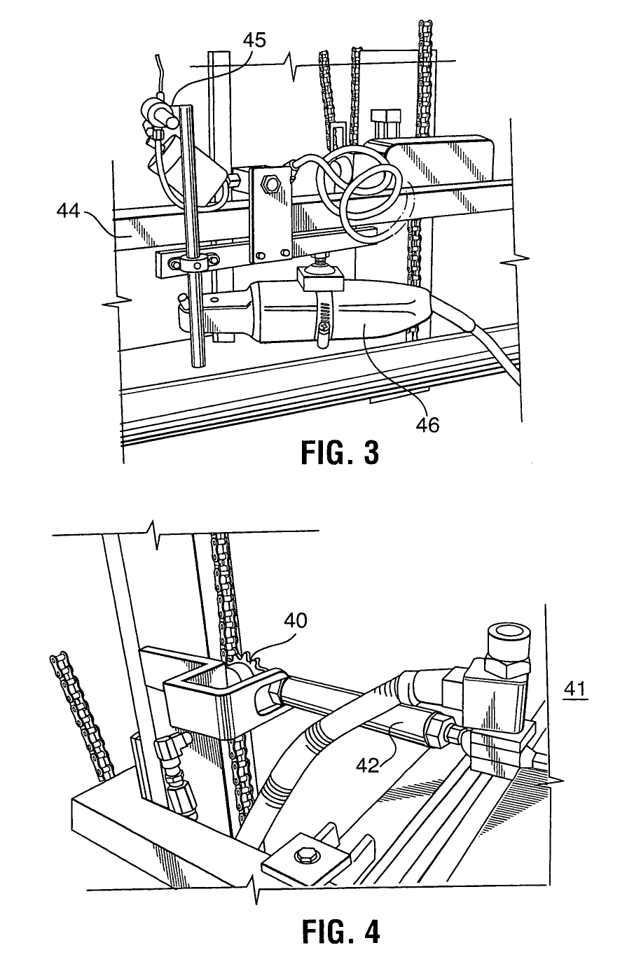

The user now moves selector switch 126 to the buckram advance position and presses buckram advance button 124. This causes controller 82 to run motor 19 to feed the material 110 a few inches further and automatically stop at a second position where the ‘width’ may be cut. At this point, controller 82 energizes a solenoid 54 which causes clamp 94 to be lowered down onto material 110 and hold material 110 tight against table 70. This will prevent material 110 left on work table 70 from dropping to the floor after power shears 46 are used to cut the new ‘width’. The user starts and pushes power shears 46 (FIG. 3) along shear guide 44 to cut material 110 at precisely the correct length. Ultraviolet marker 45 simultaneously sprays a hem line mark onto material 110 as the material is being cut. As the shears finish the cut, limit switch 47 is made and causes controller 82 to energize a solenoid 55 which opens rear clamp 95 and after a brief delay, starts motor 19 which causes the newly cut ‘width’ to rise upward. With clamp 95 still open, the newly cut free end 114 drops into clamp 95. When the user returns power shear 46 to the left most position, limit switch 43 is made, and this causes controller 82 to close clamp 95 to hold newly cut free end 114. At this point, controller 82 de-energizes solenoid 54 to open clamp 94 again. Controller 82 causes motor 19 to stop just before carrier roller 24 contacts material 110 just below shelf 97. At this point the cycle is started at the beginning, above, but, as the material 110 is pulled up into position to apply the buckram, the new ‘width’ that has just been cut is delivered onto receiver bars 27, which are in their raised position. End of cycle.

When the user has performed enough cycles and made the desired number of ‘widths’, the ‘widths’ must be removed from receiver bars 27. But first, motor 100 is started manually to lower receiver bars 27 along with the ‘widths’. Motor 100 turns shaft 72 and pulleys74 which feed cables 76 down and thus lower frames 30 with bars 27 attached thereto. Rollers 31 roll against frame 12 to keep bars 27 in a horizontal relationship as frames 30 are lowered.

A bolt of drapery material is supported in a nest of rollers forming cradle 50, as shown in FIG. 1. As material 110 is pulled from the bolt, the bolt rolls against the rollers which support the bolt and cause material 110 to feed out squarely without slipping to the left or the right on work table 70. Cradle 50 is configured to allow the bolt to freewheel or the cradle rollers may be motor driven by motor 52 if the tension in the material is critical. In this situation, motor 52 would feed out just enough material so that the desired tension would be maintained.

Further switches are provided on the operator panel for selection of auto/manual control, as well as motor jog switches, manual front and rear clamp switches, and a switch to raise and lower the receiver bars. These switches are helpful during initial threading of drapery material, maintenance and troubleshooting.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. A combination buckram applicator, pleat and hem marker and cutter for drapery material, comprising:
a frame comprising and open box like structure wherein longitudinal members form each edge of said open box structure, said frame including a work table affixed to a front side of said frame, said work table including a planar surface with buckram alignment guides, a buckram bracket configured to rotatably hold a coil of buckram to be applied to drapery material, said table also including an adjustable pleat marking alignment gauge, a front drapery material clamp fixed at a front edge of said work table, and a bolt holding cradle containing rollers which is configured to either allow a bolt of drapery material to be freely spun or said rollers may be motor driven to provide drapery material tension control if desired;
said frame also including a pair of motor driven continuous loops of chain connected by two pairs of drapery material carrier rollers, a drapery ‘width’ receiver member which is configured to be raised to a drapery ‘width’ receiving position and lowered to a drapery ‘width’ removal position, a rear drapery material clamp and shelf, said shelf being located behind a rear edge of said work table with said pair of chains moving upward vertically through a gap between said shelf and said work table, said pair chains further traversing upward to a top portion of said frame, back to a rear edge of said frame and then returning downward to a location under said shelf and said rear clamp;
power shears slidably mounted on a drapery cutting guide with a limit switch at both ends of travel on said cutting guide, said shears having an ultraviolet hem marking sprayer, one of said limit switches sensing that a cut has been performed and thus causing said controller to open said rear clamp and to drive said chain drive motor to carry a newly cut ‘width’ away from said power shears, the other of said pair of switches sensing that said power shears have been return to a power shear hold position thus causing said controller to close said rear clamp onto the newly cut free end of said drapery material;
pneumatic solenoids for controlling said ultraviolet sprayer and pneumatic cylinders for said front and rear material clamps; and
an operator panel including operational switches and a programmable controller for controlling said chain drive motor, said cradle roller motor, and said solenoids, said programmable controller receiving inputs from operator switches, limit switches and a drapery material length monitoring device, said programmable controller programmed to receive a selected cut length value and capable of controlling said clamps and said chain drive motor to deliver drapery material at a selected position to apply buckram and to deliver said drapery material at said selected cut length whereupon a user can cut said selected length of material.

2. The apparatus defined in claim 1 wherein said including an exact stop pawl which can be thrust into said pair of chains for a positive stop and wherein said motor driving said chains is couple to said chains with an overrun clutch to prevent chain breakage when said stop pawl is thrust into said chains.

3. The apparatus defined in claim 1 wherein said drapery ‘width’ receiver member is slidably connected to two rear vertical longitudinal members of said box like frame and is suspended from above by a two cables feeding from two pulleys which are driven by a receiver member motor for the purpose of raising or lowering said receiver member.

4. A method for using a combination buckram applicator, pleat and hem marker and cutter for drapery comprising the steps of inputting a selected cut length into the apparatus;
using the manual switches to thread drapery material into the apparatus;
apply a first piece of buckram through the alignment guides on the work table;
place the free end of said material into the rear clamp;
move the buckram advance/cut length selector switch to the buckram advance position;
push the buckram advance push button;
manually feed buckram with adhesive from a coil rotatably mounted on a bracket on the work table through alignment guides;
press the drapery material down against the adhesive strips on the buckram to adhere the two together;
